(19) United States
(12) Patent Application Publication
(10) Pub. No.: US 2022/0244469 A1
(43) Pub. Date: Aug. 4, 2022

(54) SYSTEM AND METHOD FOR ESTIMATING PERFORMANCE CHARACTERISTICS OF AN OPTICAL FIBER ROUTING PATH

(71) Applicant: COMMSCOPE TECHNOLOGIES LLC, Hickory, NC (US)

(72) Inventors: Enze CHEN, Herent (BE); Daniel Francois DAEMS, S-Gravenwezel (BE)

(73) Assignee: COMMSCOPE TECHNOLOGIES LLC, Hickory, NC (US)

(21) Appl. No.: 17/610,945

(22) PCT Filed: May 12, 2020
(86) PCT No.: PCT/US2020/032434

§ 371 Date: Nov. 12, 2021

Related U.S. Application Data
(60) Provisional application No. 62/847,459, filed on May 14, 2019.

(51) Int. Cl. G02B 6/38; G02B 6/44; H04B 10/07

(52) U.S. Cl. CPC G02B 6/3897; H04B 10/07; G02B 6/444

(57) ABSTRACT

Systems, methods, and computer readable products for estimating one or more performance characteristics associated with a routing path of an optical fiber. A visual image of a routed fiber is obtained. The visual image is mapped to generate a tracer curve that estimates the routing path. The tracer curve is analyzed to determine one or more characteristics of a fiber routed along the routing path, such as a failure probability over a period of time or a signal loss due to bends in the fiber.

### CROSS-REFERENCE TO RELATED APPLICATION

This application is being filed on May 12, 2020 as a PCT International Patent Application and claims the benefit of U.S. Patent Application Ser. No. 62/847,459, filed on May 14, 2019, the disclosure of which is incorporated herein by reference in its entirety.

### TECHNICAL FIELD

The present disclosure is directed to optical fibers and, particularly, to estimating reliability and/or optical performance of routing paths for optical fibers.

### BACKGROUND

Optical fibers are used in telecommunications networks to carry optical signals, such as voice and data signals between a network provider and network subscribers. The optical fibers can be managed by various fiber management components and structures, such as trays, closures, frames, cabinets, cassettes, panels, and so forth. Bending of optical fibers is controlled to avoid failure of the optical fiber, and also to reduce signal loss, changes in the modal power distribution in multi-mode, few-mode or single mode fibers, and changes in the state of polarization of the light, which can occur where the fiber bends. How much bend a given fiber can tolerate can depend on one or more parameters, such as the core material, the core thickness, the overall length of the optical fiber, and also the wavelength(s) of the signals it carries. Performance standards are set based on these and other parameters, as well as the location in the network the optical fiber will be used.

### SUMMARY

In general terms the present disclosure is directed to systems and methods for estimating one or more performance characteristics of an optical fiber routing path. The performance characteristic can be, e.g., an amount of signal loss caused by the routing path. In another example, the performance characteristic can be a probability that the fiber will fail within a predefined amount of time. In another example, a performance characteristic sought to be minimized or optimized can be changes in the modal power distribution in multi-mode, few-mode, or single mode fibers. In another example, a performance characteristic sought to be minimized or optimized can be changes in the state of polarization of the light propagating through the fiber. The routing path is mapped and analyzed to calculate one or more non-infinite bend radii defined by the routing path. In addition to using the calculated bend radii, the estimated performance characteristic depends on the fiber's parameters. Such parameters can include, e.g., a transverse thickness of the optical fiber, an axial length of the optical fiber, a location of the routed optical cable within an optical fiber network, a difference in refractive index between a fiber core and a fiber cladding of the optical fiber, the number of optical fiber cores of the optical fiber being routed, the range of transmission wavelengths of signals to be transmitted by the optical fiber, and/or a maximum transmission wavelength of signals to be transmitted by the optical cable. Using the information obtained about the routing path and one or more parameters of the fiber, one or more performance characteristics of the fiber routed along the routing path is estimated. The parameters can be input into the system via the user and/or stored in a memory of the system, e.g., in the form of a look-up table. In addition, the system itself can, in some examples, determine one or more parameters of the fiber based on a captured visual image of the fiber.

If the performance characteristic(s) does (do) not meet a predefined threshold of acceptability, the routing path can be adjusted (i.e., re-routed) and the estimating system and method run again on the adjusted routing path. This process can be repeated as many times as needed to, e.g., optimize a particular optical fiber routing path within a telecommunications network.

It should be appreciated that the methods and systems of the present disclosure can provide for improvements in optical fiber performance and reliability by helping to optimize optical fiber routing paths.

A method according to the present disclosure can be performed using a computing device. The computing device includes non-volatile memory storing computer-readable instructions and one or more processors that execute the computer readable instructions. An optical device is linked to the computing device. The optical device can include, e.g., a camera that captures visual images of routed optical fibers or optical fiber routing paths. The visual images can be provided to the computing device where the computer readable instructions cause the one or more processors to perform operations on the images. Input and output devices are also linked to the computing device. For example, a visual interface is provided on an input/output device. Via the interface, information about the optical fiber and optical fiber routing path can be displayed. In addition, commands can be input via the interface, e.g., to calculate a performance characteristic of a routed optical fiber along the fiber routing path.

According to certain aspects of the present disclosure, a method of estimating one or more performance characteristics of a routed optical fiber routed along a routing path between first and second points, comprises: obtaining a visual image of the optical fiber routed along the routing path; mapping the routing path using the visual image; and calculating, using the mapped routing path, at least one non-infinite bend radius corresponding to a discrete segment of the mapped routing path.

According to further aspects of the present disclosure, a method of estimating one or more performance characteristics of a routed optical fiber routed along a routing path between first and second points, the optical fiber having one or more parameters, comprises: obtaining a visual image of the optical fiber routed along the routing path; mapping the routing path using the visual image; calculating, using the mapped routing path, at least one non-infinite bend radius corresponding to a discrete segment of the mapped routing path; and based on the at least one calculated non-infinite bend radius and the one or more parameters, estimating the one or more performance characteristics of the routed optical fiber.

According to further aspects of the present disclosure, a method of estimating one or more performance characteristics of a routed optical fiber routed along a routing path between first and second points, the optical fiber having one or more parameters, comprises: obtaining a visual image of the optical fiber routed along the routing path; mapping the routing path using the visual image; calculating, using the mapped routing path, a plurality of non-infinite bend radii corresponding to discrete segments of the mapped routing path; and based on the plurality of non-infinite bend radii and the one or more parameters, estimating the one or more performance characteristics of the routed optical fiber.

According to further aspects of the present disclosure, a system for estimating one or more performance characteristics of a routed optical fiber routed along a routing path between first and second points, comprises: an interface; an imaging device; one or more processors; and a non-transitory computer-readable medium having stored thereon instructions that, when executed by the one or more processors, cause the one or more processors to: obtain, using the imaging device, a visual image of the optical fiber routed along the routing path; map the routing path using the visual image; and calculate, using the mapped routing path, at least one non-infinite bend radius corresponding to a discrete segment of the mapped routing path.

According to further aspects of the present disclosure, a system for estimating one or more performance characteristics of a routed optical fiber routed along a routing path between first and second points, comprises: an interface; an imaging device; one or more processors; and a non-transitory computer-readable medium having stored thereon instructions that, when executed by the one or more processors, cause the one or more processors to: obtain, using the imaging device, a visual image of the optical fiber routed along the routing path; map the routing path using the visual image; calculate, using the mapped routing path, at least one non-infinite bend radius corresponding to a discrete segment of the mapped routing path; and based on the at least one calculated non-infinite bend radius and the one or more parameters, estimate the one or more performance characteristics of the routed optical fiber.

According to yet further aspects of the present disclosure, a system for estimating one or more performance characteristics of a routed optical fiber routed along a routing path between first and second points, comprises: an interface; an imaging device; one or more processors; and a non-transitory computer-readable medium having stored thereon instructions that, when executed by the one or more processors, cause the one or more processors to: obtain, using the imaging device, a visual image of the optical fiber routed along the routing path; map the routing path using the visual image; calculate, using the mapped routing path, a plurality of non-infinite bend radii corresponding to discrete segments of the mapped routing path; and based on the plurality of non-infinite bend radii and the one or more parameters, estimate the one or more performance characteristics of the routed optical fiber.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic view of an example system in accordance with the present disclosure.

FIG. 2 depicts an example interface and display that can be displayed when using the system of FIG. 1.

FIG. 3 depicts a further example interface and display that can be displayed when using the system of FIG. 1.

FIG. 4 depicts a further example interface and display that can be displayed when using the system of FIG. 1.

FIG. 5 depicts a further example interface and display that can be displayed when using the system of FIG. 1.

FIG. 6 depicts a further example interface and display that can be displayed when using the system of FIG. 1.

FIG. 7 is a process flow illustrating an example method in accordance with the present disclosure.

FIG. 8 is a schematic representation of components of the computing device and system of FIG. 1.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

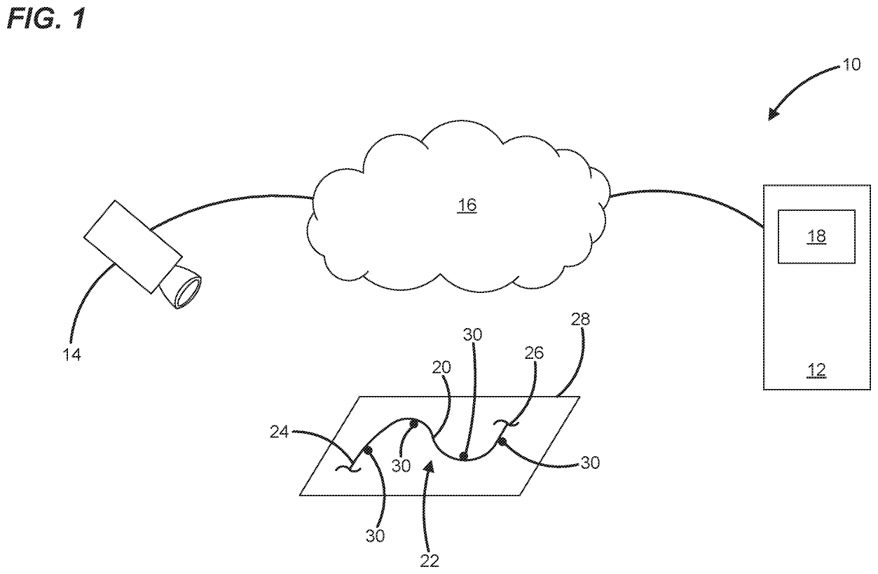

Referring to FIG. 1, an example system 10 for estimating one or more performance characteristics of a routed optical fiber or optical fiber routing path is schematically represented. The system 10 includes a computing device operatively linked to an optical device 14. In some examples, the optical device 14 and the computing device 12 are disposed in the same housing. The optical device 14 is configured to capture visual images. In some examples, the optical device 14 is a camera. The optical device 14 can be operatively linked to the computing device via one or more hard connections and/or via a remote network 16. The computing device 12 includes an interface 18. The interface 18 is configured to provide output and receive input. In some examples, the interface 18 includes a display. The computing device 12 and the optical device 14 are connectable to a power source.

The system 10 is configured to estimate one or more performance characteristics of an optical fiber 20 routed along a routing path 22 between a first end 24 and a second end 26 of the routing path 22. The fiber 20 can be routed on telecommunications equipment 28 for placement within a telecommunications network. The equipment 28 can be, e.g., a tray (e.g., for splicing and/or splitting optical fibers), a panel, a cabinet, a closure, a frame, a fiber loop organizer, etc. The equipment 28 can also consist of multiple pieces of equipment, such that the routing path 22 spans multiple pieces of Dequipment. The equipment 28 can include one or more structures 30, e.g., fiber guides, channels, spools, bend radius limiters, outer boundary walls of the equipment 28 itself, etc. The routing path 22 of the fiber 20 can be partially dictated by the structures 30. In addition, the equipment 28 and structures 30 can provide for multiple different fiber routing paths, of which one such routing path 22 is shown in FIG. 1. Selecting the optimal routing path depends on a number of factors, such as where the start and end points of the routing path need to be (e.g., for purposes of connecting the optical fiber to another optical fiber), the presence of other optical fibers routed on the same telecommunications equipment, the location of the telecommunications equipment within a telecommunications network, parameters of the fiber itself (e.g., it's length, core thickness, length of core, number of cores, the change of refractive index between core and cladding, the range of wavelengths or maximum wavelength to be transmitted by the fiber, etc.).

The bend radii of the fiber 20 along the routing path 22 can impact both the amount of loss of a signal transmitted by the fiber 20 as well as the lifetime of the optical fiber routed along the routing path 22. The bend radii of the routed fiber can impact the probability that the fiber will fail over a given period of time. This probability, as used herein, will also be referred to as a lifetime. In optimizing the routing path, the selected path, in at least some examples, must meet a predefined minimum lifetime threshold (i.e., no greater than a maximum threshold probability of failure over a given period of time (e.g., 20 years)).

The optical device 14 is positioned such that it can capture a visual image of the equipment 28 and the fiber 20. In some examples, more than one optical device is provided in the system 10. The captured visual image can be provided to the computing device 12 and stored in memory.

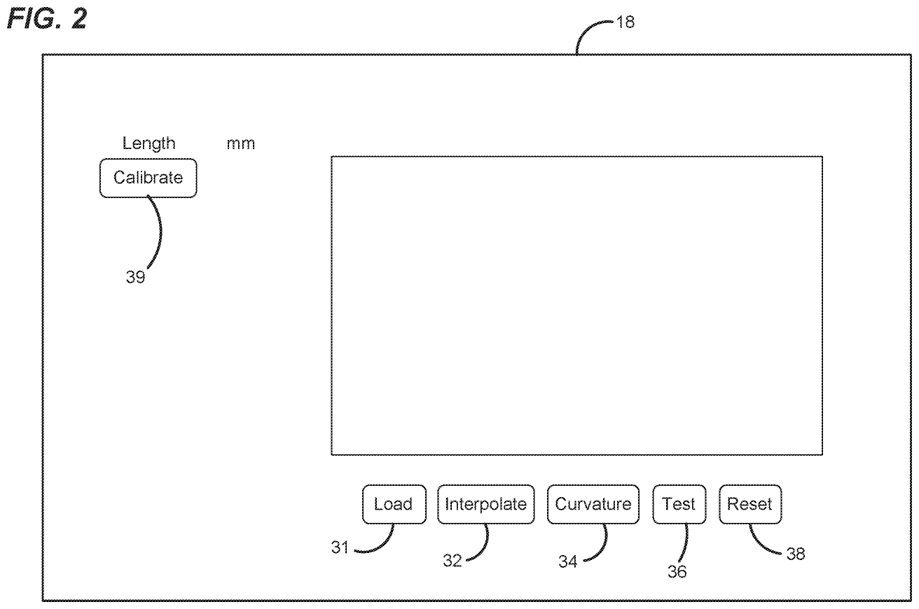

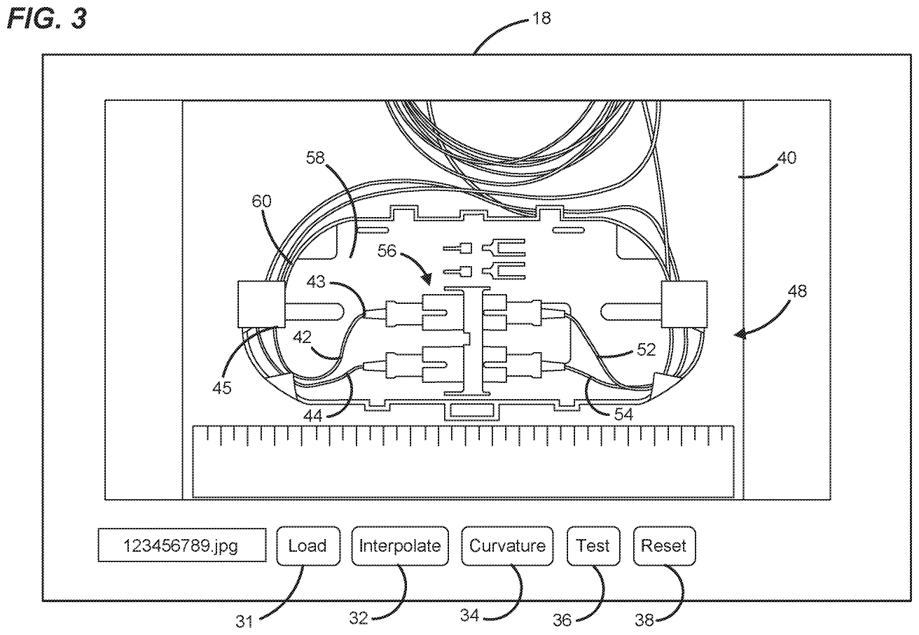

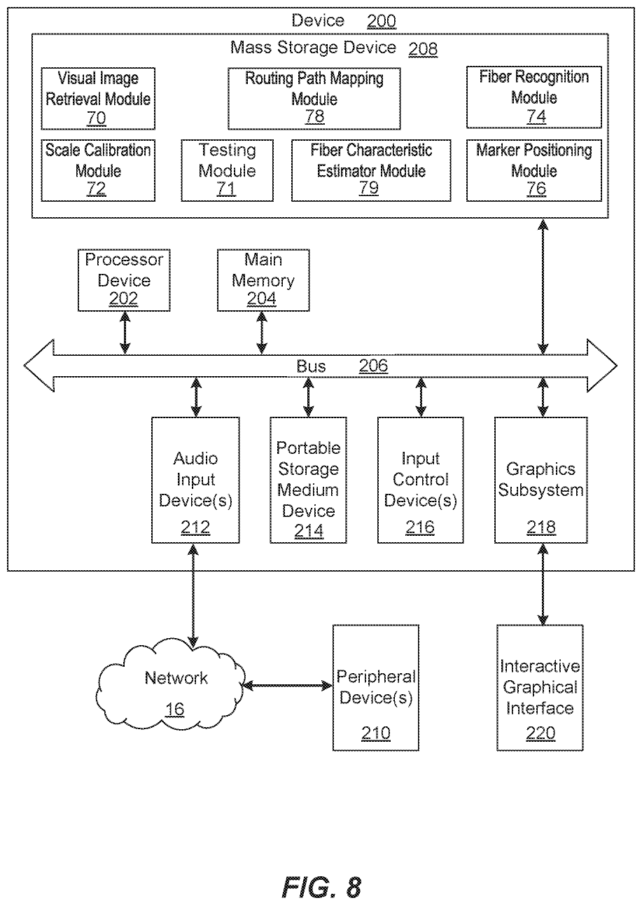

Referring to FIG. 2, an example estimation initiation graphical display is depicted on the interface 18. The display includes a plurality of selectable buttons, including a Load button 31, an Interpolate button 32, a Curvature button 34, a Test button 36, a Reset button 38, and a Calibrate button 39. Such buttons can be hard buttons or soft buttons. In this example, the buttons are soft buttons. Selecting the Load button allows a captured visual image of the routed optical fiber to be loaded and displayed on the interface 18 as shown in FIG. 3. A visual image retrieval module 70 (FIG. 8) stored on memory accessed by the one or more processors of the computing device 12 (FIG. 1) causes a captured visual image of the routed optical fiber to be loaded and displayed on the interface 18 upon selection of the Load button 31.

In FIG. 3. a visual image 40 of test routing paths of one or more optical fibers (e.g., optical fibers 42, 44) on telecommunications equipment 48 is displayed on the interface 18. The equipment 48 is used to connect the fibers 42, 44 to other fibers 52, 54 at a connector and adapter assembly 56 mounted on a cable routing surface 58 of the equipment 48. In this example, the equipment 48 is a connector tray that can be pivotally coupled to a tray support within a telecommunications closure at a distribution node of a telecommunications network. The fibers 42, 44 are routed about one or more structures 60, causing bends in the fibers 42, 44. The image can include a calibrating tool 66. For example, the image 40 includes an image of a calibrating tool 66 (e.g., a ruler) taken in the same field of view as the equipment 48.

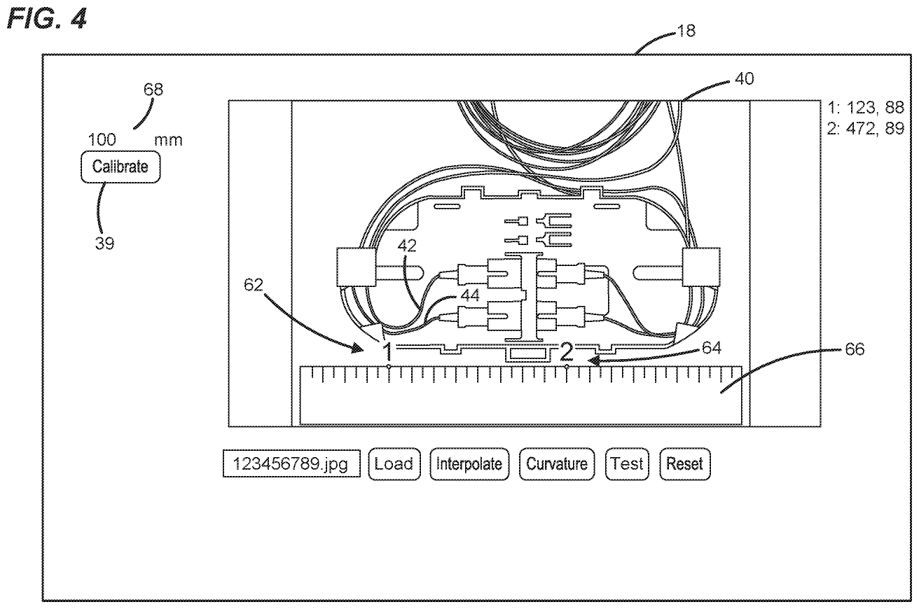

Referring to FIG. 4, the visual image 40 has been marked with markers 62 and 64 having a known actual distance therebetween by referencing the graduated markings on the calibrating tool 66. The markers 62 and 64 are readable by the computing device such that a virtual distance between the markers (i.e., relative to the visual image) can be measured by the computing device. Using the calibrating tool 66, the known physical distance between the markers is input into the calibration field 68 and the Calibrate button 39 is selected. In response to selection of the Calibrate button 39, a calibration module 72 (FIG. 8) stored on memory accessed by the one or more processors of the computing device 12 (FIG. 1) causes the visual image to be calibrated according to the calibration value input and the virtual distance in the image corresponding to the calibration value input. Calibrating the image 40 allows the system 10 (FIG. 1) to accurately calculate bend radii of the fiber(s) 40, 42.

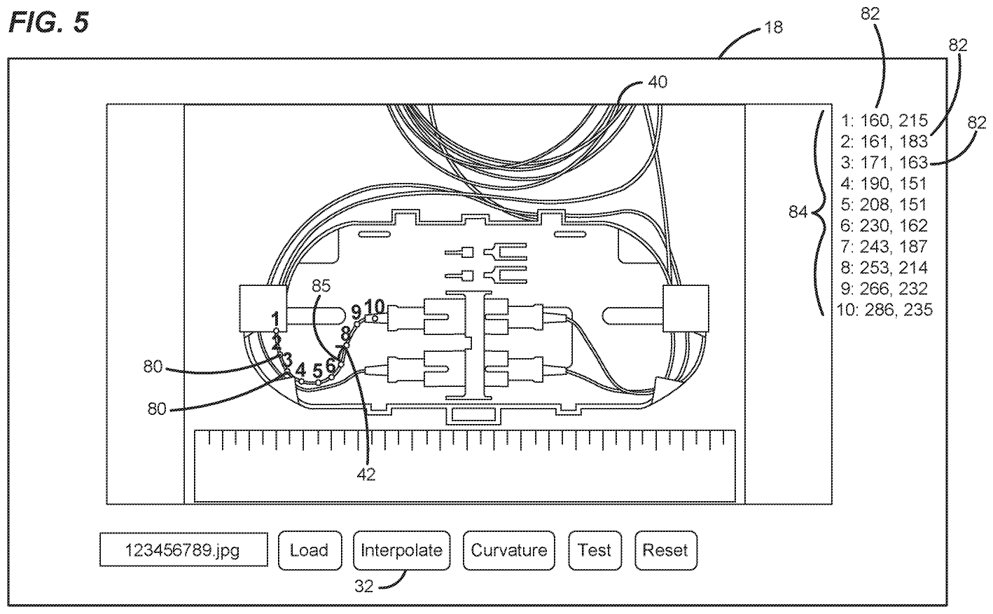

Referring to FIG. 5, markers 62 and 64 have been deleted from the visual image 40 and the visual image 40 has been marked with markers 80 that have been indexed with numbers. In this example, there are ten markers 80 with index numbers 1 through 10. Each of the markers is positioned on the image of the fiber 42. In some examples, the markers are placed through user input via the interface 18. The number and placement of the markers 80 on the fiber 42 can depend on the extent to which the curvature of the fiber 42 changes between end points 43 and 45. For example, if it is visually apparent from the visual image 40 that a portion of the routing path has a constant radius of curvature, just one marker may be placed at the portion to mark a single, discrete segment of the routing path. In another example, if it is visually apparent from the visual image 40 that a portion of the routing path has a changing radius of curvature, multiple markers may be placed along that portion to mark multiple discrete segments of the routing path.

In other examples, the markers are automatically generated by the computing device. For example, the computing device 12 can be configured to automatically recognize an image of a fiber and position markers 80 along the image of the fiber image accordingly. Such a function can be performed, e.g., by a fiber recognition module 74 (FIG. 8) stored on memory accessed by the one or more processors of the computing device 12. That is, the fiber recognition module 74 is configured to cause an image of the fiber 42 to be recognized and one or more markers placed along the routing path defined by the image of the fiber.

Once the markers 80 are positioned along the fiber image or routing path image, in some examples, locations are assigned to the markers. For example, each of the ten markers 80 is assigned a two dimensional rectilinear set of coordinates 82 relative to the visual image 40. As shown in FIG. 5, in some examples, the coordinates are displayed via the interface 18 in a marker position display area 84. The markers 80 can be assigned positions by a marker positioning module 76 (FIG. 8) stored on memory of the computing device 12. The marker positioning module 76 applies a grid to the image 40 and locates the markers 80 on the grid to assign numerical two-dimensional coordinates 82.

Once the marker positions have been assigned, the Interpolate button 32 can be selected. In response to selection of the Interpolate button 32, a routing path mapping module 78 (FIG. 8) causes a mapping of the fiber routing path along the marked area of the fiber image. With the routing path mapping module 78, the mapping generates a trace curve 85 that traces the image of the fiber portion in question. In some examples, the routing path mapping module 78 is configured to generate a visual trace curve 85 that is a cubic spline curve having at least and first and second order derivatives continuity. For example, the routing path mapping module 78 is configured to perform an iterative process of mathematically testing potential fitting of candidate curves (i.e., curves defined by difference functions) to the coordinates (i.e., data points) of the markers until the fit is optimized, resulting in the trace curve 85. In alternative examples, the routing path mapping module 78 generates a trace curve 85 based on the image of the fiber 42 and without first marking positions on the fiber.

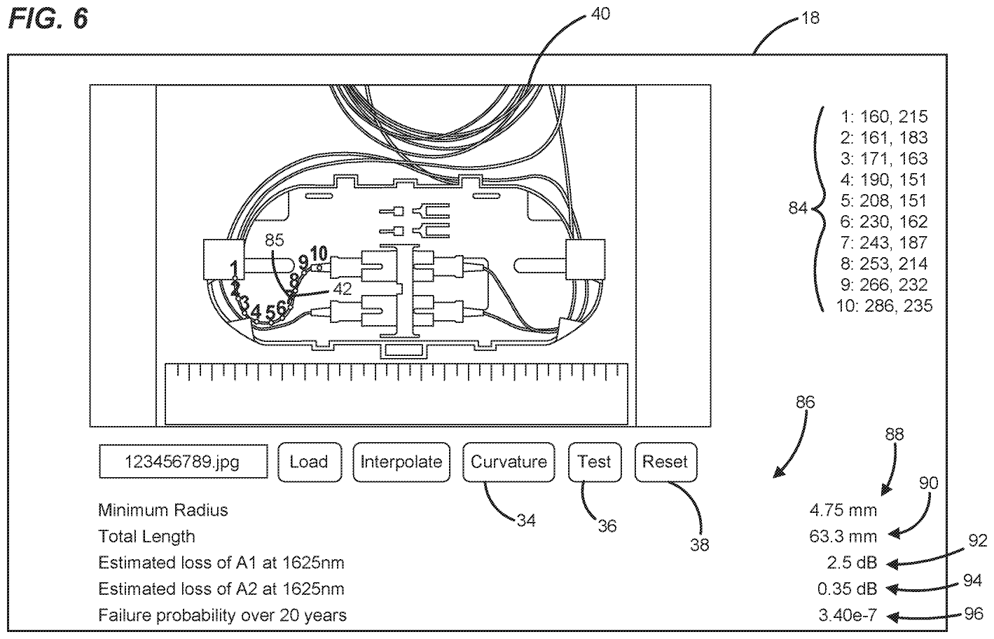

Referring to FIG. 6, following mapping of the routing path, selection of the Curvature button 34 generates, based on the trace curve 85 representing the routing path, one or more characteristics of the fiber 42 as routed, including at least one non-infinite bend radius of a discrete segment of the trace curve 85 and at least one performance characteristic. In some examples, a plurality of non-infinite bend radii of a plurality of discrete segments of the trace curve 85 are calculated. The performance characteristic can be calculated based at least in part on the calculated bend radius or bend radii. A fiber characteristic estimator module 79 (FIG. 8) stored on a memory of the computing device 12, is configured to estimate, based on the trace curve 85, the one or more bend radii and the one or more performance characteristics of the fiber 42 as routed. At least one of the bend radii and the one or more performance characteristics are displayed via the interface 18 in a fiber characteristics display area 86. In the example shown, the data displayed in the display area 86 includes an estimation of the smallest bend radius 88 of the fiber 42 as routed between the end points 43 and 45 (FIG. 3), an estimation of the total length 90 of the fiber 42 in the area of estimation (e.g., between the end points 43 and 45 (FIG. 3)), one or more estimated signal losses 92, 94 attributable to the fiber 42 based at least in part on the smallest bend radius 88 and/or the plurality of calculated bend radii, and a lifetime 96 of the fiber 42, i.e., a probability of failure of the fiber 42 over a period of time (e.g., 20 years) based at least in part on the smallest bend radius 88.

In some examples, the estimated signal loss is a sum of local signal losses estimated from a plurality of discrete segments or points along the trace curve between the first and second ends of the fiber being analyzed. In some examples, the discrete segments are infinitesimally small, and the sum of the signal losses is taken as a mathematical integral based in part on the mathematical function corresponding to the mapped trace curve. The fiber characteristic estimator module 79 can be configured to perform the summation of local signal losses. In this example, the estimated signal losses 92, 94 are combined (i.e., summed) losses along the entirety of the routing path and include an estimated loss 92 for a first fiber type (e.g., fiber type G657A1) at a defined signal wavelength (1625 nanometers) and an estimated loss 94 for a second fiber type (e.g., fiber type G657A2) at a defined signal wavelength (1625 nanometers). It should be appreciated that the estimator module 79 can be configured to estimate signal losses based on the trace curve 85 for fibers having many different combinations of parameters, with signal wavelength and fiber type being just two of such possible parameters.

Based on the estimated value(s) of the characteristic(s) of the fiber as routed and as presented in the fiber characteristics display area 86, a determination can be made as to whether the routing of the fiber 42 is acceptable or unacceptable. If it is determined that that the routing is acceptable, the fiber 42 can be kept in the analyzed routing configuration on the telecommunications equipment. If the routing is unacceptable, the routing can be adjusted, i.e., rerouted, a visual image of the rerouted fiber can be taken and loaded on to the computing device 12 for display via the interface 18, and the rerouted fiber marked, mapped and analyzed as described above to obtain estimated value(s) of the one or more characteristic(s) of the fiber as rerouted. In some examples, the system 10 is configured to suggest a rerouted path having one or more improved performance characteristics than the initial routing path. This process can be repeated as many times as needed until the estimated value(s) is/are acceptable. For example, if the estimated smallest bend radius is too small (e.g., smaller than a preset or standard minimum threshold), if the estimated signal loss is too great (e.g., greater than a preset or standard maximum threshold depending on how the fiber is being used), and/or if the failure probability is too great (e.g., greater than a preset or standard maximum threshold depending on how the fiber is being used), then the fiber can be rerouted and the estimation process performed again on the rerouted fiber.

It should be appreciated that the estimation process described herein need not be performed on the actual fiber and the actual telecommunications equipment that is to be used in the telecommunications network. Test fibers or other objects that resemble fibers and test equipment that model the actual fibers and equipment can instead be used for the estimation process. In addition, in certain embodiments, no fiber or physical object representing a fiber is required to be routed to perform the estimation. For example, a visual image can be captured of only the telecommunications equipment on which a fiber can be routed. A proposed fiber routing path can then be traced on the image (after calibrating the image as described above), and the traced path can be marked and mapped as described above to generate estimated characteristics of the routing path that would apply to a fiber if a fiber of given parameters were installed in such a routing configuration.

Optionally, a Test button 36 and/or a Reset button 38 are provided via the interface 18. In some examples, selection of the Test button triggers a testing module 71 (FIG. 8) stored on a memory of the computing device 12 to perform, via a mapping module 78 and/or the estimator module 79, one or more of the interpolation or estimation functions on, e.g., a relatively simple set of test markers, such as two test markers on a visual image. If the test fails, e.g., selection of the Test button 36 generates a nonsensical mapping or nonsensical data, the Reset button 38 can be selected to, e.g., clear the data inputs being used by the various modules. Optionally, the system can be tested again by selecting the Test button following a reset.

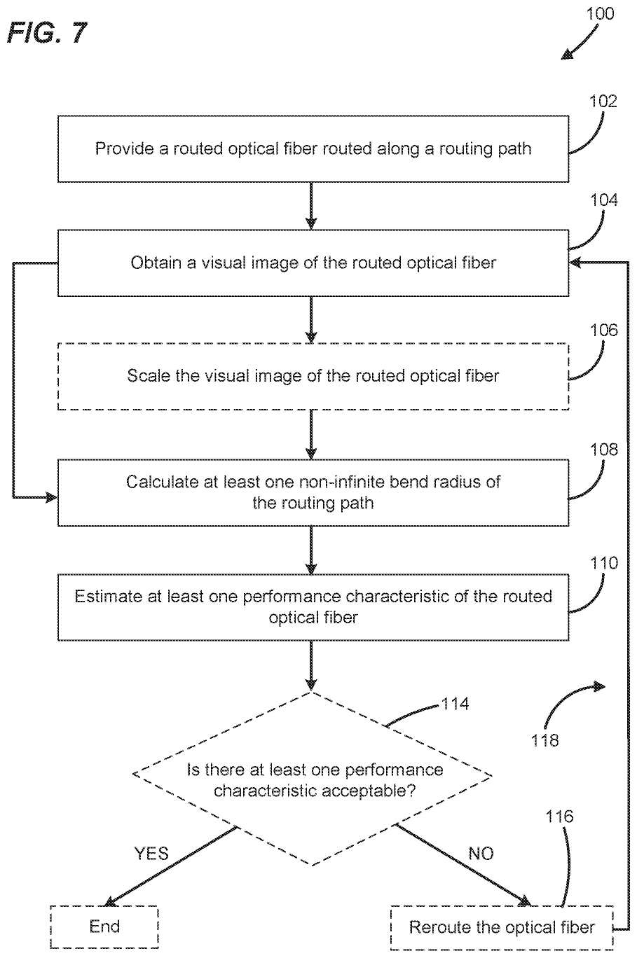

Referring now to FIG. 7, an example process flow 100 for estimating one or more performance characteristics of a routed optical fiber or a routing path of an optical fiber is depicted. In some examples, one or more operations of the process flow are performed by a computing machine in response to user inputs. In an example operation 102, a routed optical fiber routed along a routing path between first and second points is provided, the optical fiber having one or more parameters. In an example operation 104, a visual image of the optical fiber routed along the routing path is obtained. In an optional operation 106, the visual image is calibrated, e.g., using a calibrating tool. In an example operation 108, the routing path is mapped using the visual image. In an example operation 110, at least one (or a plurality) of non-infinite bend radii corresponding to discrete segments of the mapped routing path is/are calculated. In an example operation 112, based at least on the at least one or the plurality of non-infinite bend radii, a performance characteristic of the routed optical fiber is estimated. Optionally, in an example operation 114, the estimated performance characteristic is determined to be acceptable or unacceptable by comparing the estimated performance characteristic to a preset or standard threshold value for the performance characteristic. If the estimated performance characteristic is determined to be acceptable, the process ends. If the estimated performance characteristic is determined to be unacceptable, in an optional operation 116 the fiber is rerouted and the process flow returns to the operation 104, where a visual image is obtained of the rerouted fiber. The process can be repeated in a loop 118 until the estimated performance characteristic is determined to be acceptable.

Referring now to FIG. 8, there is provided a block diagram showing an exemplary computing device 200 constructed to realize one or more aspects of the example embodiments described herein. In some examples, the device 200 corresponds to the computing device 12. In these examples, the device 12 may be connected over the network 16 to one or more servers or remote devices, e.g., the optical device 14 (FIG. 1).

The device 200 includes a processing device 202, which can correspond to the one or more processors described above. Also included are a main memory 204 and an interconnect bus 206. The processor device 202 may include without limitation a single microprocessor, or may include a plurality of microprocessors for configuring the device 200 for providing the functionalities described herein. The main memory 204 stores, among other things, instructions and/or data for execution by the processor device 202. The main memory 204 may include banks of dynamic random access memory (DRAM), as well as cache memory.

The device 200 may further include a mass storage device 208, peripheral device(s) 210 (such as the optical device 14), audio input device(s) (e.g., a microphone for speech based interaction with the interface 18), portable non-transitory storage medium device(s) 212, input control device(s) 214, optionally an audio playback device (e.g., a speaker) 216, a graphics subsystem 218, and/or an output interactive graphical interface 220 (such as the interface 18 described above). For explanatory purposes, all components in the device 200 are shown in FIG. 8 as being coupled via the bus 206. However, the device 200 is not so limited. Elements of the device 200 may be coupled via one or more data transport means. For example, the processor device 202, and/or the main memory 204 may be coupled via a local microprocessor bus. The mass storage device 208, peripheral device(s) 210, portable storage medium device(s) 214, and/or graphics subsystem 218 may be coupled via one or more input/output (I/O) buses. The mass storage device 208 may be a nonvolatile storage device for storing data and/or instructions for use by the processor device 202. The mass storage device 208 may be implemented, for example, with a magnetic disk drive or an optical disk drive. In a software embodiment, the mass storage device 208 is configured for loading contents of the mass storage device 208 into the main memory 204. Memory may be embodied as one or more of mass storage device 208, main memory 204, or portable storage medium device 214.

The mass storage device 208 may also include software that, when executed, causes the device 200 to perform the features described above, including but not limited to the functions of the visual image retrieval module 70, the calibration module 72, the testing module 71, the fiber characteristic estimator module 79, the routing path mapping module 78, the fiber recognition module 74, and the marker positioning module 76.

The portable storage medium device 214 operates in conjunction with a nonvolatile portable storage medium, such as, for example, a solid state drive (SSD), to input and output data and code to and from the device 200. In some embodiments, the software for storing information may be stored on a portable storage medium, and may be inputted into the device 200 via the portable storage medium device 208. The peripheral device(s) 210 may include any type of computer support device, such as, for example, an input/output (I/O) interface configured to add additional functionality to the device 200. For example, the peripheral device(s) 210 may include a network interface card for interfacing the device 200 with a network 16.

The input control device(s) 216 provide a portion of an interface for the device 200. The input control device(s) 216 may include a keypad and/or a cursor control and/or a touch screen. The keypad may be configured for inputting alphanumeric characters and/or other key information. The cursor control device may include, for example, a handheld controller or mouse, a rotary input mechanism, a trackball, a stylus, and/or cursor direction keys. A cursor control device can be used, e.g., for selecting soft buttons displayed via the interface 18. In order to display textual and graphical information, the device 200 may include the graphics subsystem 218 and the graphical interface 220 (e.g., the interface 18 described above). The graphical interface 220 may include a display such as a TFT (Thin Film Transistor), TFD (Thin Film Diode), OLED (Organic Light-Emitting Diode), AMOLED display (active-matrix organic light-emitting diode), and/or liquid crystal display (LCD)-type displays. The displays can also be touchscreen displays, such as capacitive and resistive-type touchscreen displays.

The graphics subsystem 218 receives textual and graphical information, and processes the information for output to the output display of the interactive graphical interface 220.

Input control devices 216 can control the operation and various functions of device 200. Input control devices 216 can include any components, circuitry, or logic operative to drive the functionality of device 200. For example, input control device(s) 216 can include one or more processors acting under the control of an application.

Software embodiments of the examples presented herein may be provided as a computer program product, or software that may include an article of manufacture on a machine-accessible or machine-readable media having instructions. The instructions on the non-transitory machine-accessible, machine-readable or computer-readable medium may be used to program a computer system or other electronic device. The machine- or computer-readable medium may include, but is not limited to, magnetic disks, optical disks, magneto-optical disks, or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine, and which causes the machine to perform any one of the methods described herein. Further, it is common in the art to speak of software, in one form or another (e.g., program, procedure, process, application, module, engine, unit, logic, and so on), as taking an action or causing a result. Such expressions are merely a shorthand way of stating that the execution of the software by a processing system causes the processor to perform an action to produce a result.

Some embodiments may also be implemented by the preparation of application-specific integrated circuits, field-programmable gate arrays, or by interconnecting an appropriate network of conventional component circuits.

Some embodiments include a computer program product. The computer program product may be a storage medium or media having instructions stored thereon or therein that can be used to control, or cause, a computer to perform any of the procedures of the example embodiments of the invention. The storage medium may include without limitation an optical disc, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the system and for enabling the system or microprocessor to interact with a human user or other mechanism utilizing the results of the example embodiments of the invention. Such software may include, without limitation, device drivers, operating systems, and user applications. Ultimately, such computer-readable media further include software for performing example aspects of the invention, as described above.

Included in the programming and/or software of the system are software modules for implementing the procedures described above.

### EXAMPLE EMBODIMENTS

According to a 1^{st} example embodiment, there is provided a system for estimating one or more performance characteristics of a routed optical fiber routed along a routing path between first and second points, the system comprising: an interface; an imaging device; one or more processors; and a non-transitory computer-readable medium having stored thereon instructions that, when executed by the one or more processors, cause the one or more processors to: obtain, using the imaging device, a visual image of the optical fiber routed along the routing path; map the routing path using the visual image; and calculate, using the mapped routing path, at least one non-infinite bend radius corresponding to a discrete segment of the mapped routing path.

According to a 2^{nd} example embodiment, there is provided a system for estimating one or more performance characteristics of a routed optical fiber routed along a routing path between first and second points, the system comprising: an interface; an imaging device; one or more processors; and a non-transitory computer-readable medium having stored thereon instructions that, when executed by the one or more processors, cause the one or more processors to: obtain, using the imaging device, a visual image of the optical fiber routed along the routing path; map the routing path using the visual image; calculate, using the mapped routing path, at least one non-infinite bend radius corresponding to a discrete segment of the mapped routing path; and based on the at least one calculated non-infinite bend radius and the one or more parameters, estimate the one or more performance characteristics of the routed optical fiber.

According to a 3^{rd} example embodiment, there is provided a system for estimating one or more performance characteristics of a routed optical fiber routed along a routing path between first and second points, the system comprising: an interface; an imaging device; one or more processors; and a non-transitory computer-readable medium having stored thereon instructions that, when executed by the one or more processors, cause the one or more processors to: obtain, using the imaging device, a visual image of the optical fiber routed along the routing path; map the routing path using the visual image; calculate, using the mapped routing path, a plurality of non-infinite bend radii corresponding to discrete segments of the mapped routing path; and based on the plurality of non-infinite bend radii and the one or more parameters, estimate the one or more performance characteristics of the routed optical fiber.

According to a 4^{th} example embodiment, there is provided any of the 1^{st} through 3^{rd} example embodiments, wherein the routing path is mapped by marking a plurality of points along the routing path shown by the visual image to provide data points representative of the routing path, and mathematically fitting one or more curves to the data points to provide a trace of the routing path.

According to a 5^{th} example embodiment, there is provided any of the 1^{st} through 3^{rd} example embodiments, wherein the routing path is mapped by a computing device generating a trace of the routing path of the visual image.

According to a 6^{th} example embodiment, there is provided the 4^{th} example embodiment, wherein the at least one curve includes a cubic spline curve.

According to a 7^{th} example embodiment, there is provided the 2^{nd} or 3^{rd} example embodiment, wherein the one or more performance characteristics includes a signal loss of the routed optical fiber.

According to an 8^{th} example embodiment, there is provided the 3^{rd} example embodiment, wherein the one or more performance characteristics includes a signal loss of the routed optical, and wherein the signal loss is calculated by summing signal losses associated with the discrete segments.

According to a 9^{th} example embodiment, there is provided the 2^{nd} or 3^{rd} example embodiment, wherein the one or more performance characteristics includes a probability of failure of the routed optical fiber within a predefined duration of time.

According to a 10^{th} example embodiment, there is provided the 2^{nd} or 3^{rd} example embodiment, wherein the one or more parameters includes a length of the optical fiber.

According to an 11^{th} example embodiment, there is provided the 2^{nd} or 3^{rd} example embodiment, wherein the one or more parameters includes a location of the routed optical fiber within an optical fiber network.

According to a 12^{th} example embodiment, there is provided the 2^{nd} or 3^{rd} example embodiment, wherein the one or more parameters includes a difference in refractive index between a fiber core and a fiber cladding of the optical fiber.

According to a 13^{th} example embodiment, there is provided the 2^{nd} or 3^{rd} example embodiment, wherein the one or more parameters includes a range of transmission wavelengths of signals to be transmitted by the optical fiber.

According to a 14^{th} example embodiment, there is provided the 2^{rd} or 3^{rd} example embodiment, wherein the one or more parameters includes a maximum transmission wavelength of signals to be transmitted by the optical fiber.

According to a 15^{th} example embodiment, there is provided any of the 1^{st} through 14^{th} example embodiments, wherein the instructions, when executed by the one or more processors, cause the one or more processors to calibrate the visual image to obtain a calibrated visual image.

According to a 16^{th} example embodiment, there is provided the 1^{st} example embodiment, wherein the calibrate is performed using a calibrating tool.

According to a 17^{th} example embodiment, there is provided the 16^{th} example embodiment, wherein the calibrating tool is a graduated ruler visible in the visual image.

According to an 18^{th} example embodiment, there is provided any of the 15^{th} through 17^{th} example embodiments, wherein the instructions, when executed by the one or more processors, cause the one or more processors to, using the calibrated visual image, determine a length of the routing path between the first and second points.

According to a 19^{th} example embodiment, there is provided the 2^{nd} or 3^{rd} example embodiment, wherein the routing path is a first routing path, and wherein the instructions, when executed by the one or more processors, cause the one or more processors to, based on the estimated one or more performance characteristics, reroute the optical cable along a second routing path that is different from the first routing path.

According to a 20^{th} example embodiment, there is provided any of the 2^{rd} through 19^{th} example embodiments, wherein the interface includes a visual display.

According to a 21^{st} example embodiment, there is provided the 20^{th} example embodiment, wherein the system is configured to display the one or more performance characteristics on the visual display.

According to a 22^{nd} example embodiment, there is provided the 2^{nd} or 3^{rd} example embodiment, wherein the optical fiber is one of a multi-mode, few-mode, or single mode fiber, and wherein the one or more performance characteristics includes changes in the modal power distribution in multi-mode, few-mode or single mode, respectively.

According to a 23^{rd} example embodiment, there is provided the 2^{nd} or 3^{rd} example embodiment, wherein the one or more performance characteristics includes changes in a state of polarization of light propagated by the optical fiber.

From the foregoing detailed description, it will be evident that modifications and variations can be made in the devices of the disclosure without departing from the spirit or scope of the invention.

1. A method of estimating one or more performance characteristics of a routed optical fiber routed along a routing path between first and second points, the method comprising:
obtaining a visual image of the optical fiber routed along the routing path;
mapping the routing path using the visual image; and
calculating, using the mapped routing path, at least one non-infinite bend radius corresponding to a discrete segment of the mapped routing path.

2. A method of estimating one or more performance characteristics of a routed optical fiber routed along a routing path between first and second points, the optical fiber having one or more parameters, the method comprising:
obtaining a visual image of the optical fiber routed along the routing path;
mapping the routing path using the visual image;
calculating, using the mapped routing path, at least one non-infinite bend radius corresponding to a discrete segment of the mapped routing path; and
based on the at least one calculated non-infinite bend radius and the one or more parameters, estimating the one or more performance characteristics of the routed optical fiber.

3. A method of estimating one or more performance characteristics of a routed optical fiber routed along a routing path between first and second points, the optical fiber having one or more parameters, the method comprising:
obtaining a visual image of the optical fiber routed along the routing path;
mapping the routing path using the visual image;
calculating, using the mapped routing path, a plurality of non-infinite bend radii corresponding to discrete segments of the mapped routing path; and
based on the plurality of non-infinite bend radii and the one or more parameters, estimating the one or more performance characteristics of the routed optical fiber.

4. The method of claim 1, wherein the routing path is mapped by marking a plurality of points along the routing path shown by the visual image to provide data points representative of the routing path, and mathematically fitting one or more curves to the data points to provide a trace of the routing path.

5. The method of claim 1, wherein the routing path is mapped by a computing device generating a trace of the routing path of the visual image.

6. The method of claim 4, wherein the at least one curve includes a cubic spline curve.

7. The method of claim 2, wherein the one or more performance characteristics includes a signal loss of the routed optical fiber.

8. The method of claim 3, wherein the one or more performance characteristics includes a signal loss of the routed optical, and wherein the signal loss is calculated by summing signal losses associated with the discrete segments.

9. The method of claim 2, wherein the one or more performance characteristics includes a probability of failure of the routed optical fiber within a predefined duration of time.

10. The method of claim 2, wherein the one or more parameters includes a length of the optical fiber.

11. The method of claim 2, wherein the one or more parameters includes a location of the routed optical fiber within an optical fiber network.

12. The method of claim 2, wherein the one or more parameters includes a difference in refractive index between a fiber core and a fiber cladding of the optical fiber.

13. The method of claim 2, wherein the one or more parameters includes a range of transmission wavelengths of signals to be transmitted by the optical fiber.

14. The method of claim 2, wherein the one or more parameters includes a maximum transmission wavelength of signals to be transmitted by the optical fiber.

15. The method of claim 1, further comprising calibrating the visual image to obtain a calibrated visual image.

16. The method of claim 15, wherein the calibrating is performed using a calibrating tool.

17. The method of claim 16, wherein the calibrating tool is a graduated ruler visible in the visual image.

18. The method of claim 15, further comprising, using the calibrated visual image, determining a length of the routing path between the first and second points.

19. The method of claim 2, wherein the routing path is a first routing path, and wherein the method further comprises, based on the estimated one or more performance characteristics, rerouting the optical cable along a second routing path that is different from the first routing path.

20. The method of claim 2, wherein the optical fiber is one of a multi-mode, few-mode, or single mode fiber, and wherein the one or more performance characteristics includes changes in the modal power distribution in multi-mode, few-mode or single mode, respectively.

21. The method of claim 2, wherein the one or more performance characteristics includes changes in a state of polarization of light propagated by the optical fiber.

22. The method of claim 2, further comprising:
displaying the one or more performance characteristics on a visual display.

23. The method of claim 1, further comprising displaying the image on a visual display.

24. The method of claim 4, further comprising displaying the visual image, including the plurality pf points, on a visual display.
